(19) United States
(12) Patent Application Publication
(10) Pub. No.: US 2004/0145799 A1
(43) Pub. Date: Jul. 29, 2004

(54) Controlling optical receiver transimpedance amplifier and receive diode operational settings

(76) Inventor: Pavle Sedic, Santa Clara, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/723,605

(22) Filed: Nov. 26, 2003

Related U.S. Application Data
(60) Provisional application No. 60/429,752, filed on Nov. 27, 2002.

(51) Int. Cl. G02F 2/00

(52) U.S. Cl. 359/325

(57) ABSTRACT

A transimpedance amplifier (TIA) is adjustable for various modes of operation in which the TIA is to be used. A controller communicates a selected mode of operation to the TIA or directly to receive diode using an indicator signal. With this indicator signal, the TIA is adjusted to change one or more of its operational settings as desired for the selected mode of operation.

### CROSS REFERENCE TO RELATED APPLICATIONS

This application claims the benefit of U.S. Provisional Application No. 60/429,752, filed Nov. 27, 2002, which is hereby incorporated in its entirety by reference.

### BACKGROUND

1. Field of the Invention

The invention relates to the field of optical receiver applications using transimpedance amplifiers with optical receive diodes.

2. Background of the Invention

In an optical communication system, an optical receiver senses light energy transmitted over an optical medium, such as a fiber optic cable or air. The optical receiver converts the light energy, which carries modulated data, into an electrical data signal for further processing by the communications hardware. In a typical optical receiver, the incoming light signal is directed to an optical diode, which produces an electrical current in response to light energy. Coupled to the optical diode is a transimpedance amplifier (TIA), which converts the current from the optical diode into an electrical voltage signal. The electrical voltage signal is then amplified (e.g., by a limiting amplifier), and the data modulated thereon are extracted. For improved performance and better receiver sensitivity, the TIA is typically packaged together in the same case with the optical receive diode.

Like any electrical component, the operational settings of a TIA affect its overall performance in the system. The operational settings of a TIA that can affect its performance may include, but are not limited to, transimpedance gain, bandwidth, DC offset, signal rise and fall time, power consumption, and output impedance. For best performance, therefore, the TIA is designed to have the operational settings that best suit its intended application. For example, a TIA's operational settings may be designed to suit the data rate of the optical communications system, the protocol or standard to be used in the system, and/or the communications hardware to be used with the TIA. Additionally, a variety of other conditions or intended applications may drive the design of the TIA's operational settings.

Because TIAs are usually optimized for a particular application, their performance suffers when used in other applications. For example, a TIA designed for a system conforming to the OC-3 SONET specification may not be able to achieve an optimal data rate or efficiency when used in a system conforming to the OC-48 SONET specification. Or worse, such a TIA would fail to operate when used in a system for which it was not designed. Other TIAs have been designed with wide bandwidths and other operational settings to specifically accommodate a wide range of applications, but this affects the total performance of the TIA at a selected application.

Increasingly, TIAs are used in multi-rate and multi-protocol applications. Because of the deficiencies mentioned above, existing TIAs do not achieve the best performance and compliance with the standards under all operating conditions. If is therefore desirable to have a TIA that can be used in various applications without suffering from the inherent inefficiency of not being designed for a specific application.

### SUMMARY OF THE INVENTION

A TIA is therefore provided that can be adapted to the application in which the TIA is to be used. A particular application or use for a TIA is associated with a mode of operation, which reflects a set of requirements such as a data rate or a particular protocol. Based on the mode of operation to the TIA, one or more operational settings of the TIA are adjusted. This allows a single TIA to be used in various applications without suffering from the inherent inefficiency of not being designed for a specific application.

In one embodiment, an optical communication system comprises a controller and a transimpedance amplifier. Knowing the selected mode of operation, the controller communicates an indicator signal based on the selected mode of operation to the transimpedance amplifier. Using the communicated indicator signal, the transimpedance amplifier detects the mode of operation and adjusts at least one of its operational settings based on the detected mode of operation. The operational settings that can be adjusted include one or more of transimpedance gain, bandwidth, DC offset, signal rise and fall time, power consumption, and output impedance.

In another embodiment, a transimpedance amplifier having adjustable operational settings comprises an electrical interface for coupling to a receive diode and a transimpedance amplifier circuit in communication with the electrical interface for converting a current from the receive diode into an output voltage. The transimpedance amplifier circuit including one or more components that can be adjusted to affect at least one operational setting of the transimpedance amplifier. A settings control module coupled to the transimpedance amplifier circuit is used to adjust the adjustable components of the transimpedance amplifier circuit. The transimpedance amplifier may further include a mode detection module that determines a mode of operation for the transimpedance amplifier and communicates that mode to the settings control module. The settings control module can then adjust the adjustable components using the mode of operation, thereby controlling the performance of the transimpedance amplifier depending on its mode of operation.

The indicator can be communicated to the transimpedance amplifier in a variety of ways. In one example, the indicator is transmitted as a bias voltage through an existing bias pin or other electrical interface. In alternative embodiments, the indicator is transmitted as a digital signal, during a non-operational period of the amplifier, and/or modulated on another signal transmitted to the amplifier.

### BRIEF DESCRIPTION OF THE DRAWINGS

FIG. 1 is a schematic diagram of an optical receiver in accordance with an embodiment of the invention.

FIG. 2 is a schematic diagram of an embodiment of the mode detection module 140 shown in FIG. 1.

FIG. 3 is a schematic diagram of a transimpedance amplifier having adjustable operational settings in accordance with an embodiment of the invention.

### DETAILED DESCRIPTION OF THE PREFERRED EMBODIMENTS

FIG. 1 is a diagram of an optical receiver used in an optical communications system. At this reception end, data modulated onto a light signal are received by an optical receiving diode 105. These data may be transmitted to the diode 105 through various media, including fiber optic cable and air, in accordance with known techniques. The light energy sensed by the diode 105 causes a corresponding electrical current in the diode 105. Receiving this induced electrical current, a transimpedance amplifier (TIA) 110 is coupled to the diode 105. The TIA 110 includes a TIA circuit 115 that converts the current into an output voltage signal. In this way, the data modulated on the light signal are converted into an electrical current by the diode 105 and then into a voltage signal by the TIA 110. In this form, the data on the voltage signal can be further amplified (e.g., by a limiting amplifier) and processed by the communications system.

The TIA 110 is designed to operate in any of a plurality of modes of operation. A mode of operation is associated with a particular application for the TIA 110, such as a particular data rate, a protocol, or a combination of requirements. For a given mode of operation, a designer will determine the operational settings that the TIA 110 should have for optimal performance. These operational settings may include parameters such as transimpedance gain, bandwidth, DC offset, signal rise and fall time, power consumption, and output impedance. For example, transimpedance gain can be adjusted to cover appropriate dynamic operating range or for an automatic gain control (AGC). Bandwidth and power consumption are often adjusted depending on the data rate. With the DC offset, it is possible to adjust different time constants depending on the protocol rate and data disparity, while in some applications it is desirable to adjust the rise and fall times to control the signal shape to reduce signal ringing, lower voltage drops on the parasitic inductances, and improve signal integrity. Lastly, the TIA's output impedance can be matched to the limiting amplifier for better impedance matching. By adjusting these or other operational settings, the TIA 110 can be configured for a wide variety of modes of operation.

To allow adjustment of the TIA's operational settings, the TIA circuit 115 includes one or more adjustable components 120 that can affect the performance of the TIA 110. Depending on the design of the TIA 110, the component 120 may include one or a combination of a variety of electrical devices, including variable resistors, variable impedances, variable current sources, programmable digital logic, microprocessors, software or firmware modules, and the like. Accordingly, the adjustable component 120 may include or incorporate any device for which an adjustment thereof causes an affect on the performance of the TIA 110. In this way, one or more operational settings of the TIA 110 can be adjusted by appropriately adjusting the component 120.

A controller 125 is coupled to the TIA 110 to control the adjustment of its operational settings. The controller 125 includes a mode information module 130 that receives information about the desired mode of operation for the TIA 110. The mode information module 130 may receive and store the mode information in a variety of different ways. For example, the mode information may be acquired from a select pin, allowing a user to select the desired mode of operation directly. Alternatively, the mode information module 130 may include a set of registers or other interface for receiving mode information from another device, such as a microprocessor coupled to the mode information module 130.

The mode information module 130 generates an indicator signal that is associated with the selected mode of operation. The controller 125 is coupled to the TIA 110 for communicating this indicator signal, from which the TIA 110 can determine the selected mode. In one embodiment, the mode information is stored by the mode information module 130 in digital form. This digital information is converted by a digital to analog converter (DAC) 135 into a particular analog voltage, the value of which is based on the digital input. Alternatively, the controller 125 may indicate the mode of operation using indicators other than a DC diode bias voltage from the DAC 135. For example, a mode of operation may be indicated by a voltage, current, frequency, or bit pattern sent from the controller 125. Techniques for providing the indicator signal include encoding the indicator as a minor voltage offset from a reference voltage, sending the indicator in an analog or digital signal during a non-operational phase of the TIA 110, and modulating the indicator signal at a frequency that can be filtered and determined by the mode detection module 140.

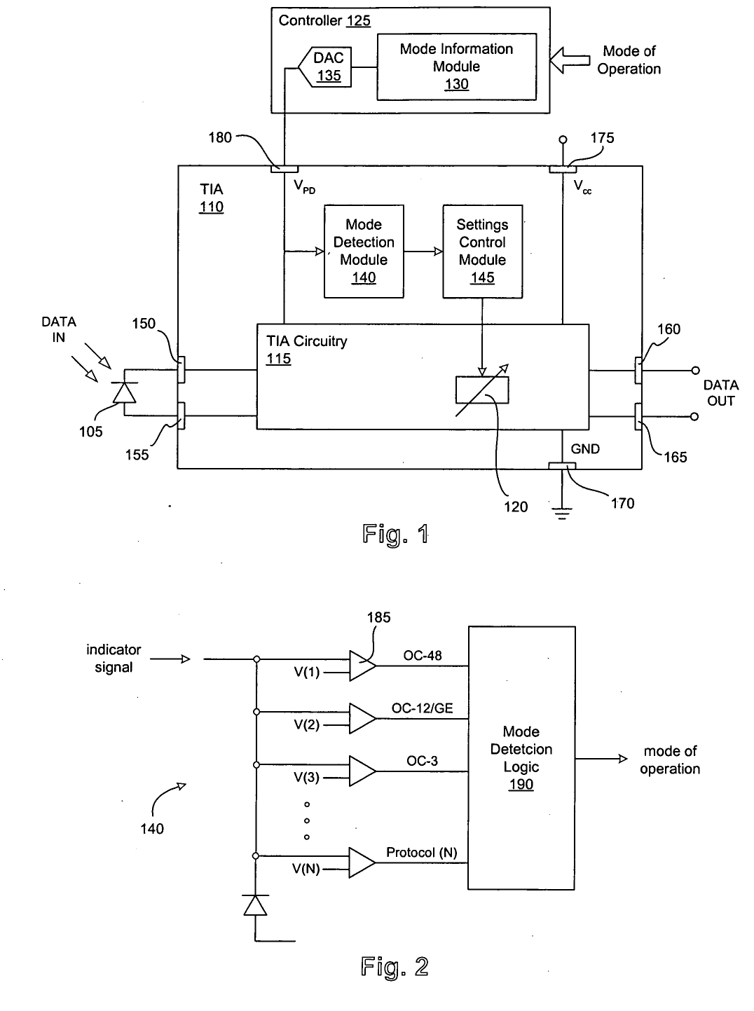

The TIA 110 includes a mode detection module 140 that is coupled to receive the indicator signal. Based on the indicator signal, the mode detection module 140 determines the selected mode of operation. Depending on the format of the indicator signal, the mode detection module 140 may take a variety of forms, and one embodiment of the mode detection module 140 is described below in connection with FIG. 2. Once the mode detection module 140 identifies the selected mode, it communicates that information to the settings control module 145. The settings control module 145 then adjusts one or more components 120 of the TIA circuit 115, thereby adjusting the operational settings of the TIA 110. In this way, the TIA 110 can determine the correct operational settings it should have based on the indicated mode of operation and, responsively, can adjust these settings at any time.

In an alternative embodiment, the indicator signal received from the controller 125 is used to adjust the components 120 directly. This obviates the need for a mode detection module 140 to determine the mode of operation or a settings control module 145 to generate an appropriate control signal for adjusting the components 120. A benefit of this approach may be to simplify the TIA 110 by reducing the required circuitry inside it.

A typical TIA 110 includes a number of electrical interfaces for communication and for proper biasing. For example, the TIA 110 shown in FIG. 1 includes data input pins 150,155 for receiving the diode current; output pins 160,165 for providing the output voltage signal; a ground pin 170 and a bias voltage pin 175 for biasing the TIA circuit 115; and a diode bias voltage pin 180 for biasing the optical diode 105. The indicator signal can be provided to the mode detection module 140 through any of these existing pins or through a special dedicated interface.

Leveraging the existence of the existing pins avoids the need for a special dedicated pin, which could otherwise add cost, size, and complexity to the TIA 110. In the embodiment shown in FIG. 1, the indicator signal is provided to the mode detection module through the diode bias voltage pin (V_{PD}) 180. The bias voltage required for a typical receiving diode 105 can be in a wide range, from the minimum bias voltage to the diode's maximum reverse voltage or the power supply voltage. By altering the diode bias voltage, therefore, the indicator signal can be provided through the diode bias voltage pin 180 along with the diode bias voltage. Although the diode bias voltage varies slightly, it remains within the required bias voltage for the diode 105 so that the diode 105 remains properly biased.

FIG. 2 is a diagram of a mode detection module 140 for detecting the selected mode of operation based on an indicator signal transmitted through the diode bias voltage pin 180. To implement the indicator signal, the controller 125 selects the diode bias voltage to vary relative to reference voltages V(1), V(2), V(3), through V(N). The mode detection module 140 includes a number of comparators 185, each of which compares the received diode bias voltage to a corresponding reference voltage. In an embodiment enabling N modes of operation, N−1 comparators 185 and reference voltages may be used.

Mode detection logic 190 is coupled to the comparators 185. The result of comparators 185 indicates the relative voltage of the indicator signal related to the reference voltages, from which the mode detection logic 190 determines the selected mode of operation for the TIA 110. For example, when the bias voltage V_{PD} is above V(1), the OC-48 mode is selected, and the appropriate operational settings such as bandwidth and transimpedance gain will be adjusted for this mode of operation. Similarly, when the bias voltage V_{PD} is below V(1) and above V(2), the OC-12/GE mode is selected, and when the bias voltage V_{PD} is below V(2), the OC-3 mode is selected, and the operational settings of the TIA 110 are adjusted according to the selected mode of operation. In one example, when the OC-3 mode is selected, bandwidth decreases, transimpedance gain increases, power decreases due to the slower rate of operation, and the time constant for the AGC and offset cancellation increase. As FIG. 2 shows, additional modes of operation may be supported, limited only by the permissible voltage range for the diode bias voltage and the sensitivity of the mode detection module 140.

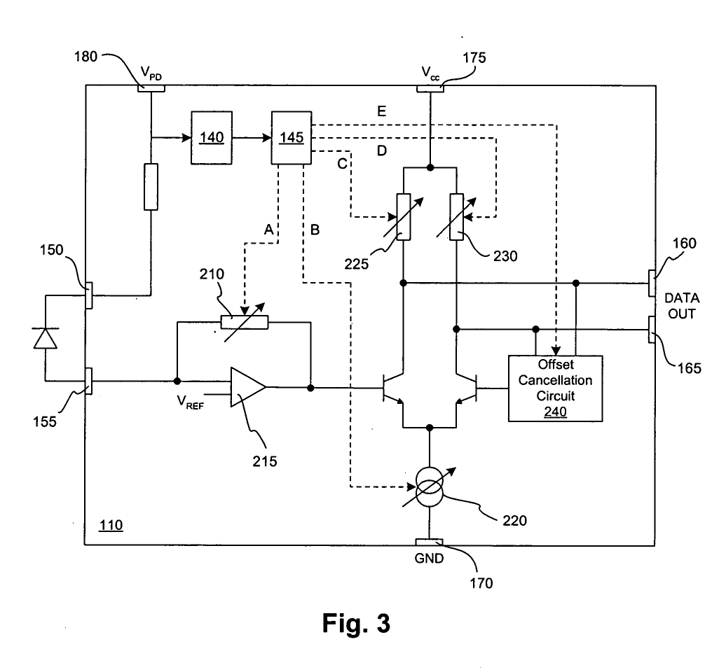

FIG. 3 illustrates a transimpedance amplifier having adjustable operational settings, including a schematic representation of various embodiments of the adjustable TIA circuit 115. As described above, the mode detection module 140 determines the selected mode of operation and informs the settings control module 145. Because each mode of operation is associated with a set of operational settings for the TIA 110, the settings control module 145 knows what operational settings the TIA 110 should have. As needed, therefore, the settings control module 145 adjusts one or more of the adjustable components within the TIA circuit 115.

The TIA circuit 115 shown in FIG. 3 is one example of a TIA implementation, and the invention can be equally applied to any of a number of TIA designs. Precisely which components are adjusted to achieve the desired operational settings depends largely on the particular design of the TIA circuit 115. Accordingly, when a TIA circuit 115 is designed, its appropriate parameters for different modes of operation are determined, and these parameters are adjusted by the settings control module 145 when it is desired to change the TIA's mode of operation. The examples shown in FIG. 3 are provided to illustrate and describe the invention. The ways in which the settings control module 145 can adjust one or more operational settings of the TIA 110 are limited only by the possible designs of a TIA.

In one example, the settings control module 145 sends control signal A to adjust a variable impedance 210 used in the feedback loop of an amplifier 215, thereby adjusting the gain of the amplifier 215. In the TIA circuit 115 shown, these components act as a filter. Decreasing the gain of the amplifier 215 increases the bandwidth of the TIA 110, while increasing that gain decreases the bandwidth of the TIA 110. In this way, control signal A adjusts the bandwidth of the TIA 110.

In another example, control signal B adjusts the current source 220. Increasing the current through the current source 220 decreases the output signal rise and fall time. In some applications, it is desirable to adjust the rise and fall times to control the signal shape to reduce signal ringing, lower voltage drops on the parasitic inductances, and improve signal integrity.

In another example, the settings control module 145 adjusts the output impedance of the TIA using control signals C and D, which adjust variable impedances 225 and 230, respectively. The output impedance of the TIA 110 is affected by impedances 225 and 230; therefore, adjusting these impedances 225 and 230 enables impedance matching between the TIA 110 and a limiting amplifier or other hardware.

In another example, the settings control module 145 sends a control signal E to control the operation of an offset cancellation circuit 240. The offset cancellation circuit 240 controls the DC offset of the TIA output voltage. Within the offset cancellation circuit 240, it is possible to adjust different time constants depending on the protocol rate and data disparity.

In another embodiment, the receive diode bias control signal is used to adjust the bandwidth and receiver gain of the receive optical diode 105 directly. The receive diode 105 may have adjustable operational settings based on its bias voltage (V_{PD}) and/or based on a control signal. In one example, the bandwidth of the diode 105 is changed by changing the bias voltage that affects the capacitance of the receive diode 105. In another example, the diode 105 can be coupled to receive a control signal from the settings control module 145. This control signal is then used to directly affect the bandwidth and responsivity of the receive diode 105. These techniques can be used alone or in combination with the techniques described above.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

I claim:

1. An optical communication system having adjustable operational settings to accommodate a plurality of modes of operation, the system comprising:
a controller adapted to communicate an indicator signal based on a selected mode of operation; and
a transimpedance amplifier having at least one adjustable operational setting, the transimpedance amplifier in communication with the controller for receiving the indicator signal and configured to adjust the at least one adjustable operational setting based on the indicator signal.

2. The system of claim 1, wherein the transimpedance amplifier comprises:
a mode detection module adapted to receive the indicator signal and determine a mode of operation based on the indicator signal; and
a settings control module in communication with the mode detection module, the settings control module coupled to the transimpedance amplifier circuit for adjusting at least one of the adjustable components based on the determined mode of operation.

3. The system of claim 2, wherein the mode detection module determines the mode of operation by comparing the indicator signal to one or more reference voltages.

4. The system of claim 2, wherein the mode detection module receives the indicator signal during a non-operational period of the transimpedance amplifier.

5. The system of claim 2, wherein the indicator signal is a digital signal, and the mode detection module includes digital circuitry for determining the mode of operation.

6. The system of claim 2, wherein the mode detection module determines the mode of operation by demodulating the indicator signal from a voltage input received from an external source.

7. The system of claim 2, wherein the mode detection module comprises means for detecting the mode of operation based on the indicator signal.

8. The system of claim 1, wherein the controller is configured to receive information related to the mode of operation for the transimpedance amplifier, the controller including an indicator generator for generating the indicator signal based on the mode of operation.

9. The system of claim 8, wherein the controller further includes a digital to analog converter for generating an analog indicator signal.

10. The system of claim 1, wherein the transimpedance amplifier includes a bias voltage interface for receiving a bias voltage, the controller communicating the indicator signal to the transimpedance amplifier as a bias voltage through the bias voltage interface.

11. The system of claim 10, wherein the indicator signal is within a permissible range of bias voltages for the transimpedance amplifier, the mode detection module determining the mode of operation by comparing the indicator signal to one or more reference voltages.

12. The system of claim 1, wherein at least one adjustable operational setting is transimpedance gain.

13. The system of claim 1, wherein at least one adjustable operational setting is bandwidth.

14. The system of claim 1, wherein at least one adjustable operational setting is selected from a group consisting of: DC offset, signal rise time, signal fall time, power consumption, and output impedance.

15. A transimpedance amplifier having adjustable operational settings, the transimpedance amplifier comprising:
an electrical interface for coupling to a receive diode;
a transimpedance amplifier circuit in communication with the electrical interface for converting a current from the receive diode into an output voltage, the transimpedance amplifier circuit including one or more adjustable components, the adjustment of which affects at least one operational setting of the transimpedance amplifier; and
a settings control module coupled to the transimpedance amplifier circuit for adjusting at least one of the adjustable components.

16. The transimpedance amplifier of claim 15, further comprising:
a mode detection module adapted to determine a mode of operation for the transimpedance amplifier, the mode detection module coupled to the settings control module for communicating the determined mode of operation, wherein the settings control module adjusts at least one of the adjustable components based on the determined mode of operation.

17. The transimpedance amplifier of claim 16, wherein the mode detection module is adapted to receive an indictor signal and determines the mode of operation based on the indicator signal.

18. The transimpedance amplifier of claim 16, further comprising:
a bias voltage interface coupled to provide the transimpedance amplifier circuit with a bias voltage, the bias voltage interface further coupled to communicate the indicator signal to the mode detection module.

19. The transimpedance amplifier of claim 18, wherein the bias voltage interface provides the transimpedance amplifier circuit with a diode bias voltage for the receive diode.

20. The transimpedance amplifier of claim 15, wherein at least one of the adjustable components includes a means for adjusting the transimpedance gain of the transimpedance amplifier.

21. The transimpedance amplifier of claim 15, wherein at least one of the adjustable components includes a means for adjusting the bandwidth of the transimpedance amplifier.

22. The transimpedance amplifier of claim 15, wherein at least one of the adjustable components includes a means for adjusting the an operational setting selected from a group consisting of: DC offset, signal rise time, signal fall time, power consumption, and output impedance.

23. A transimpedance amplifier having one or more operational settings that are adjustable based on a mode of operation for an associated optical communication system, the transimpedance amplifier comprising:
means for receiving an indicator associated with the mode of operation;
means for detecting the mode of operation based on the indicator; and
means for adjusting at least one operational setting of the transimpedance amplifier based on the detected mode of operation.

24. The transimpedance amplifier of claim 23, wherein at least one adjustable operational setting is selected from a group consisting of: transimpedance gain, bandwidth, DC offset, signal rise time, signal fall time, power consumption, and output impedance.

25. A method for adjusting an operational setting of a transimpedance amplifier based on a mode of operation for an associated optical communication system, the method comprising:
receiving an indicator associated with the mode of operation;
detecting the mode of operation based on the indicator; and
adjusting at least one operational setting of the transimpedance amplifier based on the detected mode of operation.

26. The method of claim 25, wherein the indicator is received as a bias voltage for the transimpedance amplifier.

27. The method of claim 26, wherein the mode of operation is detected by comparing the received indicator to at least one reference voltage.

28. The method of claim 26, wherein the mode of operation is associated with a selected protocol.

29. The method of claim 26, wherein the mode of operation is associated with a data rate.

30. The method of claim 26, wherein at least one adjusted operational setting is transimpedance gain.

31. The method of claim 26, wherein at least one adjusted operational setting is bandwidth.

32. The method of claim 26, wherein at least one adjusted operational setting is selected from a group consisting of: DC offset cancellation, signal rise time, signal fall time, power consumption, and output impedance.
